(19) United States
(12) Patent Application Publication
(10) Pub. No.: US 2014/0196770 A1
(43) Pub. Date: Jul. 17, 2014

(54) PHOTOVOLTAIC MODULE AND SYSTEM

(71) Applicant: University of Central Florida Research Foundation, Inc., Orlando, FL (US)

(72) Inventor: Earl Harvey Jacobs, IV, Rockledge, FL (US)

(73) Assignee: University of Central Florida Research Foundation, Inc., Orlando, FL (US)

(21) Appl. No.: 14/158,214

(22) Filed: Jan. 17, 2014

Related U.S. Application Data
(60) Provisional application No. 61/753,648, filed on Jan. 17, 2013.

(51) Int. Cl. H01L 31/048; H01L 31/042; H01L 31/18; H01L 31/05

(52) U.S. Cl. CPC H01L 31/0485; H01L 31/05; H01L 31/0424; H01L 31/18
USPC 136/251; 136/259; 29/592.1

(57) ABSTRACT

In at least one aspect of this disclosure, a photovoltaic module includes a frame, at least one photovoltaic cell disposed on the frame, a photovoltaic junction box electrically connected to the at least one photovoltaic cell and having a first photovoltaic junction box terminal and a second a photovoltaic junction box terminal, a first frame terminal electrically connected to the first photovoltaic junction box terminal via a first wire disposed within the frame, a second frame terminal electrically connected to the second photovoltaic junction box terminal via a second wire disposed within the frame, a third frame terminal, and a fourth frame terminal electrically connected to the third frame terminal via a third wire.

### CROSS-REFERENCE TO RELATED APPLICATIONS

The present application claims priority to U.S. Provisional Patent Application No. 61/753,648, filed on Jan. 17, 2013, the entire contents of which are herein incorporated by reference.

### BACKGROUND

1. Field

The present disclosure relates to photovoltaic panels, more specifically to systems and methods for connecting photovoltaic panels.

2. Description of Related Art

A photovoltaic panel is a packaged, connected assembly of photovoltaic cells. One or more photovoltaic panels can be mounted to a frame to form a photovoltaic module which can more readily be mounted to a desired surface or structure. Multiple photovoltaic modules can be connected together (i.e. in series and/or parallel) and used as components of a photovoltaic array configured to generate electricity, e.g., for commercial and/or residential applications.

When connecting photovoltaic modules together, the electrical wiring used may be exposed creating a potential safety/durability hazard as well as an aesthetic problem. Improved wiring systems for photovoltaic modules may be desired. This disclosure provides solutions for this need.

### SUMMARY

In at least one aspect of this disclosure, a photovoltaic module includes a frame, at least one photovoltaic cell disposed on the frame, and a photovoltaic junction box electrically connected to the at least one photovoltaic cell. The photovoltaic junction box includes a first photovoltaic junction box terminal and a second a photovoltaic junction box terminal. A first frame terminal is electrically connected to the first photovoltaic junction box terminal via a first wire disposed within the frame, and a second frame terminal is electrically connected to the second photovoltaic junction box terminal via a second wire disposed within the frame. The photovoltaic module also includes a third frame terminal and a fourth frame terminal that is electrically connected to the third frame terminal via a third wire.

The frame can include one or more channels configured to allow the first, second, and third wires to be contained therein. The frame can be configured to be slidably mounted onto a structure and to be connected to one or more other photovoltaic modules on the structure.

In some embodiments, the second frame terminal can be configured to releasably mate with the first frame terminal disposed on another of the photovoltaic modules. The fourth frame terminal can be configured to releasably mate with the third frame terminal disposed on another of the photovoltaic modules.

In some embodiments, the first and second frame terminals or the third and fourth frame terminals can be configured to magnetically couple to one or more terminals on another photovoltaic module. The third wire can form at least a portion of the home run wire. Further, at least one of the first, second, third, or fourth frame terminals can be contained inside the frame and can be configured to transfer electrical power via magnetic fields.

In at least one aspect of this disclosure, a system includes at least first and second photovoltaic modules as disclosed herein, wherein the first frame terminal of the second photovoltaic module is releasably connected to the second frame terminal of the first photovoltaic module, and wherein the third frame terminal of the second photovoltaic module is releasably connected to the fourth frame terminal of the first photovoltaic module.

The system can further include a jumper cable releasably connected to the second and fourth frame terminals of the second photovoltaic module. In some embodiments, the system can further include an output cable releasably connected to the first and third frame terminals of the first photovoltaic module. The system can further include an inverter or junction box connected to the output cable.

In at least one aspect of this disclosure, a method includes providing a rack for mounting photovoltaic modules adjacent to one another, providing at least a first and second photovoltaic module as disclosed herein, attaching the first photovoltaic module to the rack, releasably connecting the first frame terminal of the second photovoltaic module to the second frame terminal of the first photovoltaic module and releasably connecting the third frame terminal of the second photovoltaic module to the fourth frame terminal of the first photovoltaic module, and attaching the second photovoltaic module to the rack.

The method can further include connecting a jumper cable to the second and fourth frame terminals of the second photovoltaic module. In some embodiments, the method can further include connecting an output cable to the first and third frame terminals of the first photovoltaic module. The method can further include connecting an inverter or junction box to the output cable.

In some embodiments, the method can further include attaching additional photovoltaic modules in parallel or series with at least one of the first or second photovoltaic modules. The method can further include determining an amount of photovoltaic modules to connect in series suitable to output a desired voltage. The method can further include determining an amount of photovoltaic modules to connect in parallel suitable to output a desired current. The method can further include labeling the second, third, and fourth frame terminals on each photovoltaic module as positive and the first frame terminal as negative.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a systematic view of a system in accordance with this disclosure;

FIG. 2 is partial, cross-sectional view of adjoining photovoltaic modules similar to those shown in FIG. 1, showing the connections in more detail; and

FIG. 3 is a partial, perspective view of adjoining frames of the photovoltaic modules of FIG. 1, showing wiring extending from inside the frame.

### DETAILED DESCRIPTION

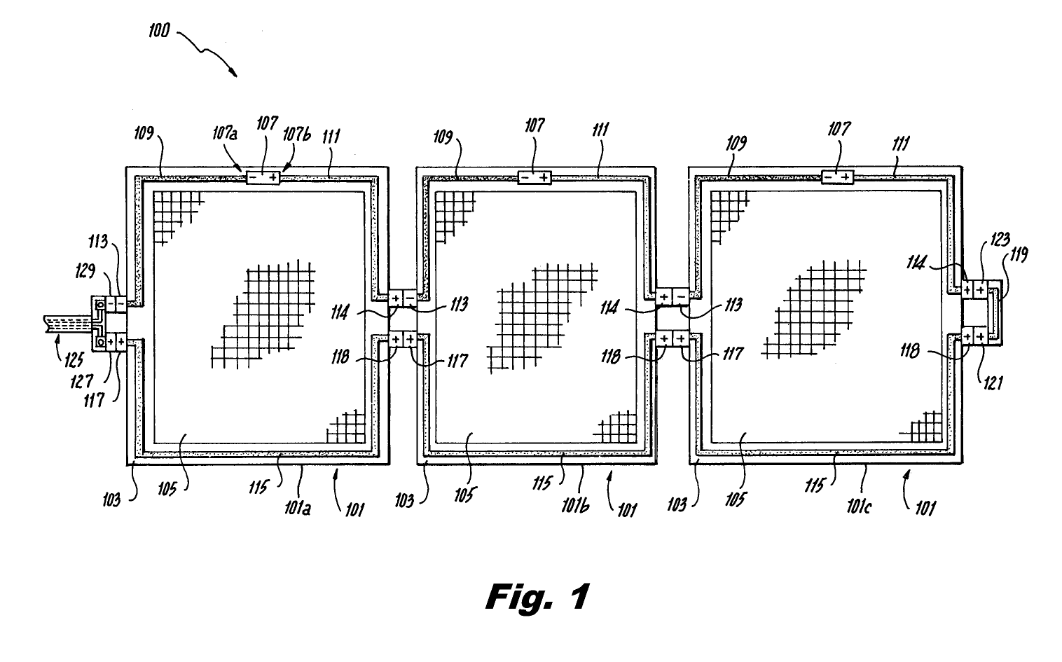

Reference will now be made to the drawings wherein like reference numerals identify similar structural features or aspects of the subject disclosure. For purposes of explanation and illustration, and not limitation, the FIGS. 1-3 show features of embodiments of a system in accordance with this disclosure. The systems, apparatuses, and methods described herein can be used to quickly and safely connect photovoltaic modules without leaving exposed wiring.

Referring generally to FIGS. 1-3 a photovoltaic module 101 can include one or more photovoltaic cells 105 disposed on a frame 103. The frame 103 can include one or more channels configured to allow one or more wires and/or other suitable electrical connections to be disposed therein. The frame 103 can also be configured to slidably mount onto a structure (e.g. a panel rack, a roof, a building, etc.) and to be connected to one or more other photovoltaic modules 101 on the structure.

A photovoltaic junction box 107 can be electrically connected to the at least one photovoltaic cell 105. The photovoltaic junction box 107 can include a first photovoltaic junction box terminal 107a and a second a photovoltaic junction box terminal 107b. While the

FIG. 1 shows the terminals 107a, 107b of photovoltaic junction box 107 as electrically negative on the left side and electrically positive on the right side (relative to the orientation of FIG. 1), the reverse, or any other suitable configuration is contemplated. The photovoltaic junction box 107 may be disposed within frame 103 or any other suitable place on photovoltaic module 101. A first frame terminal 113 is electrically connected to the first photovoltaic junction box terminal 107a via a first wire 109 or via any other suitable electrical connection. The first wire 109 can be disposed within the frame 103. In some embodiments, the first frame terminal 113 is labeled to indicate the same electrical charge (e.g., negative as shown in the embodiment of FIG. 1) as the first photovoltaic junction box terminal 107a, however, the first frame terminal 113 can be labeled or unlabeled in any suitable manner. The labeling as described herein can facilitate proper connection of the photovoltaic modules 101 with other modules or electrical devices to ensure a proper current path. In some embodiments, the photovoltaic modules can be configured to only allow connection in the proper orientation (e.g., via terminals that can only mate with the proper terminal) such that wrongly positioned devices will not connect.

A second frame terminal 114 is electrically connected to the second photovoltaic junction box terminal 107b via a second wire 111 or via any other suitable electrical connection. The second wire 111 can be disposed within the frame 103. In some embodiments, the second frame terminal 114 is labeled to indicate the same electrical charge (e.g., positive as shown in the embodiment of FIG. 1) as the second photovoltaic junction box terminal 107b, however, the second frame terminal 113 can be labeled or unlabeled in any suitable manner.

Photovoltaic module 101 can further include a third frame terminal 117 and a fourth frame terminal 118 that is electrically connected to the third frame terminal 117 via a third wire 115 or any other suitable electrical connection. The third frame terminal 117 and the fourth frame terminal 118 can be labeled the same (e.g. positive as shown in FIG. 1), or be otherwise labeled/unlabeled in any suitable manner. In some embodiments, the first frame terminal 113 and the third frame terminal 117 are labeled with opposite electrical charge symbols while the second frame terminal 114 and the fourth frame terminal 118 are labeled the same. The third wire 115 can form at least a portion of a return wire, referred to as a “home run.”

As shown in FIGS. 1-3, the first and third frame terminals 113, 117 can be arranged in a suitable pair and/or the second and fourth frame terminals 114, 118 can be arranged in a suitable pair. Such an arrangement can allow suitable electrical linking of panels 101 to each other. The pairing arrangement as shown in FIGS. 1-3 allows for linking photovoltaic modules in series in a line/plane, however, any other suitable configuration is contemplated (e.g. such that the terminals allow for a non-linear and/or 3-dimensional module linkage). Moreover, the external terminals 113, 114, 117, 118 can be configured for one or more parallel electrical connections in addition to, or instead of, the series connections as shown in FIGS. 1-3.

In some embodiments, the second frame terminal 114 can be configured to releasably mate with the first frame terminal 113 disposed on another of the photovoltaic modules 101 (e.g. the second frame terminal 114 of the first module 101a to the first frame terminal 113 of middle module 101b in FIG. 1) and/or the fourth frame terminal 118 can be configured to releasably mate with the third frame terminal 117 disposed on another of the photovoltaic modules 101 (e.g. the fourth frame terminal 118 of the first module 101a to the third frame terminal 117 of middle module 101b in FIG. 1). The mating of the terminals 113, 114, 117, 118 can be via any suitable manner, such as, but not limited to, snap-fit, friction fit, magnetic attraction, adhesive, welding, bonding, compressive abutment, and/or the like. In some embodiments, the terminals 113, 114, 117, 118 can include one or more MC3 connectors and/or MC4 connectors sold by Westinghouse Electric Corporation of 20 Stanwix Street, Pittsburgh, Pa. 15222, or the like.

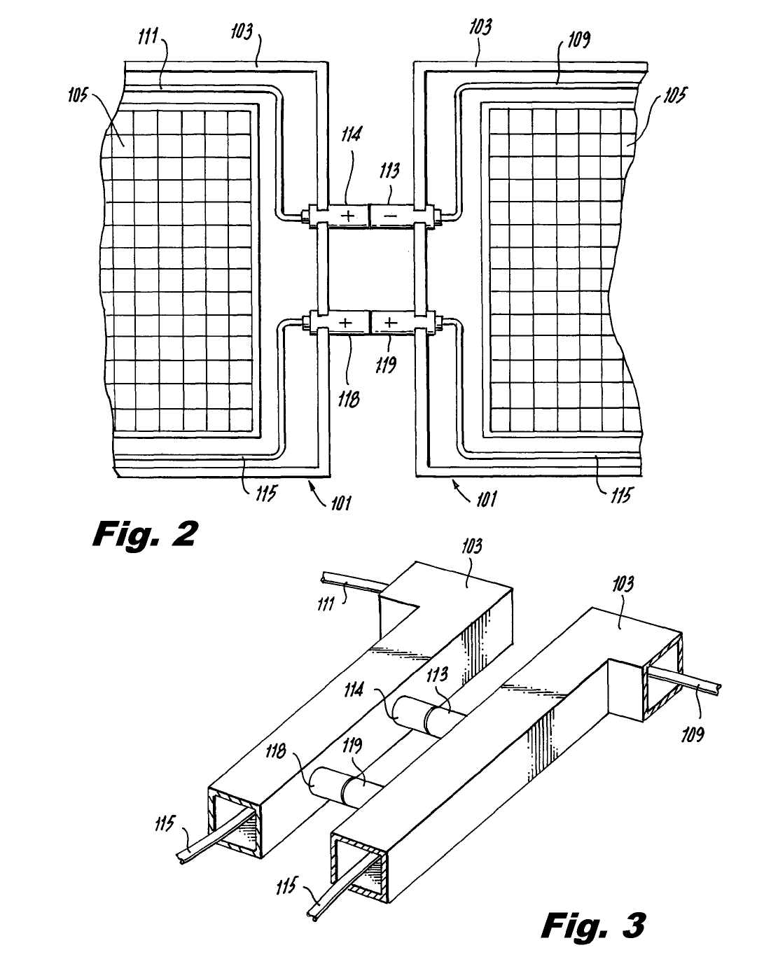

The frame terminals 113, 114, 117, 118 can be mounted to the frame 103 in any suitable manner. For example, referring to FIG. 2, frame terminals 113, 114, 117, 118 can be bolted to the frame 103, or otherwise clamp fitted to the frame 103.

In the embodiments shown in FIGS. 1-3, wires 109, 111, and 115 are disposed within the frame 103 (e.g., see FIG. 3). Including the wiring within frame 103 can prevent damage to the wires and reduces the hazard of an electrical failure or short. More particularly, the “home run” (e.g. comprised of connected third wires 115) is concealed and protected instead of being externally routed from the last photovoltaic module 101 (e.g. end module 101c in FIG. 1) of an array to the return path of an output cable 125.

In some embodiments, the at least one of the terminals 113, 114, 117, 118 can be disposed inside the frame 103 and can be configured to transfer electrical power via magnetic fields (e.g. magnetic induction). In such an instance, additional circuitry (e.g. batteries, capacitors, resistors, inductors, DC-AC inverters, and the like) may be included inside the frame 103 to allow for induction coupling of the terminals when multiple photovoltaic modules 101 are disposed within a suitable range. This can eliminate the effects of exposure to the elements on the terminals and increase the life of the terminals that are disposed within the frame 103. In some embodiments, all of terminals 113, 114, 117, 118 and wires 109, 111, and 115 can be disposed within the frame 103.

As disclosed herein, the photovoltaic module 101 can be configured to electrically connect with other similar photovoltaic modules 101, or any other suitable photovoltaic module such that an array of photovoltaic modules can be created to produce energy for any desired application.

In some embodiments, a photovoltaic module 100 (e.g. end module 101c) can further include a jumper cable 119 that electrically links the second frame terminal 114 and the fourth frame terminal 118 to close the circuit. As shown in FIG. 1, the jumper cable 119 can be external of the end module 101c and include a first and second end terminal 121, 123 which can connect to the second frame terminal 114 and fourth frame terminal 118 in any suitable manner.

In other embodiments, the jumper cable 119 can be integrated into the frame 103 of the end module 101c, or the second photovoltaic junction box terminal 107b of end module 101c can be directly connected to the third frame terminal 117 of the end module 101c to internally close the circuit.

Referring to FIG. 1, a photovoltaic system 100 can include one or more photovoltaic modules 101 as disclosed herein. While three modules are shown, any suitable number of photovoltaic modules can be included. The system 100 as shown includes a first module 101a, middle module 101b, and end module 101c.

As shown, the first frame terminal 113 of the second photovoltaic 101b module is releasably connected to the second frame terminal 114 of the first photovoltaic module 101a, and the third frame terminal 117 of the second photovoltaic module 101b is releasably connected to the fourth frame terminal 118 of the first photovoltaic module 101a. The middle module 101b and the end module 101c have a similar connection scheme as between the first module 101a and the second module 101b.

The system 100 can further include a jumper cable 119 as disclosed herein that is connected to the second and fourth frame terminals 114, 118 of the end module 101c to close the circuit. In other embodiments, the end module 101c can have an integrated jumper cable as described herein or any other suitable connection within the frame 103 of the end module 101c that is configured to close the circuit when the end module 101 is attached, similar to that as described above.

In some embodiments, the system 100 can further include an output cable 125 releasably connected to the first and third frame terminals 113, 117 of the first module 101a. The system 100 can further include an inverter or junction box connected to the output cable 125 where the electrical power is converted and/or directed for use in any suitable application. The output cable 125 can be configured to include first output terminal 127 and second output terminal 129 that can connect to one or more of the terminal 113, 114, 117, 118 of the photovoltaic module 101.

One having ordinary skill in the art would know how to reconfigure the connections and terminals as disclosed herein to allow for one or more parallel connections alternative or conjunctive to the series connections shown in FIGS. 1 and 2.

As shown, the system 100 allows for all wiring and/or other electrical connections, including the “home run” (formed by segments of third wire 115), to be contained within the frames 103 of each module. This shields the wiring from the elements adding to the longevity and safety of the electrical wiring. Containment of the wiring can also be aesthetically pleasing.

In at least one aspect of this disclosure, a method includes providing a rack for mounting two or more photovoltaic modules 101 adjacent to one another and providing at least a first and second photovoltaic module as disclosed herein. The method also includes attaching the first photovoltaic module to the rack, releasably connecting the second frame terminal of the second photovoltaic module to the first frame terminal of the first photovoltaic module and releasably connecting the fourth frame terminal of the second photovoltaic module to the third frame terminal of the first photovoltaic module, and attaching the second photovoltaic module to the rack.

The method can further include connecting a jumper cable to the second and fourth frame terminals of the second photovoltaic module. In some embodiments, the method can further include connecting an output cable to the first and third frame terminals of the first photovoltaic module. The method can further include connecting an inverter or junction box to the output cable.

In some embodiments, the method can further include attaching additional photovoltaic modules in parallel or series with at least one of the first or second photovoltaic modules. The method can further include determining an amount of photovoltaic modules to connect in series suitable to output a desired voltage. The method can further include determining an amount of photovoltaic modules to connect in parallel suitable to output a desired current. The method can further include labeling the second, third, and fourth frame terminals on each photovoltaic module as positive and the first frame terminal as negative.

While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. A photovoltaic module, comprising:
a frame;
at least one photovoltaic cell disposed on the frame;
a photovoltaic junction box electrically connected to the at least one photovoltaic cell and having a first photovoltaic junction box terminal and a second a photovoltaic junction box terminal;
a first frame terminal electrically connected to the first photovoltaic junction box terminal via a first wire disposed within the frame;
a second frame terminal electrically connected to the second photovoltaic junction box terminal via a second wire disposed within the frame;
a third frame terminal; and
a fourth frame terminal electrically connected to the third frame terminal via a third wire.

2. The photovoltaic module of claim 1, wherein the frame includes one or more channels configured to allow the first, second, and third wires to be contained therein.

3. The photovoltaic module of claim 1, wherein the second frame terminal is configured to releasably mate with the first frame terminal disposed on another of the photovoltaic modules.

4. The photovoltaic module of claim 1, wherein the fourth frame terminal is configured to releasably mate with the third frame terminal disposed on another of the photovoltaic modules.

5. The photovoltaic module of claim 1, wherein the first and second frame terminals or the third and fourth frame terminals are configured to magnetically couple to one or more terminals on another photovoltaic module.

6. The photovoltaic module of claim 1, wherein the frame is configured to be slidably mounted onto a structure and to be connected to one or more other photovoltaic modules on the structure.

7. The photovoltaic module of claim 1, wherein the third wire is at least a portion of the home run wire.

8. The photovoltaic module of claim 1, wherein at least one of the first, second, third, or fourth frame terminals are contained inside the frame and are configured to transfer or receive electrical power via a magnetic field.

9. A system, comprising:
a first and second photovoltaic module, each photovoltaic module comprising:
a frame;
at least one photovoltaic cell disposed on the frame;
a photovoltaic junction box electrically connected to the at least one photovoltaic cell and having a first photovoltaic junction box terminal and a second a photovoltaic junction box terminal;
a first frame terminal electrically connected to the first photovoltaic junction box terminal via a first wire disposed within the frame;
a second frame terminal electrically connected to the second photovoltaic junction box terminal via a second wire disposed within the frame;
a third frame terminal; and
a fourth frame terminal electrically connected to the third frame terminal via a third wire,
wherein the first frame terminal of the second photovoltaic module is releasably connected to the second frame terminal of the first photovoltaic module, and wherein the third frame terminal of the second photovoltaic module is releasably connected to the fourth frame terminal of the first photovoltaic module.

10. The system of claim 9, further comprising a jumper cable releasably connected to the second and fourth frame terminals of the second photovoltaic module.

11. The system of claim 9, further comprising an output cable releasably connected to the first and third frame terminals of the first photovoltaic module.

12. The system of claim 11, further comprising an inverter or junction box connected to the output cable.

13. A method, comprising:
disposing electrical wire within a frame of first and second photovoltaic modules;
attaching the first photovoltaic module to a rack;
releasably connecting a first frame terminal of the second photovoltaic module to a second frame terminal of the first photovoltaic module and releasably connecting a third frame terminal of the second photovoltaic module to a fourth frame terminal of the first photovoltaic module; and
attaching the second photovoltaic module to the rack.

14. The method of claim 13, further comprising connecting a jumper cable to the second and fourth frame terminals of the second photovoltaic module.

15. The method of claim 13, further comprising connecting an output cable to the first and third frame terminals of the first photovoltaic module.

16. The method of claim 15, further comprising connecting an inverter or junction box to the output cable.

17. The method of claim 13, further comprising attaching additional photovoltaic modules in parallel or series with at least one of the first or second photovoltaic modules.

18. The method of claim 13, further comprising determining an amount of photovoltaic modules to connect in series suitable to output a desired voltage.

19. The method of claim 13, further comprising determining an amount of photovoltaic modules to connect in parallel suitable to output a desired current.

20. The method of claim 13, further comprising labeling the second, third, and fourth frame terminals on each photovoltaic module as positive and the first frame terminal as negative.
